(19) United States
(12) Patent Application Publication
(10) Pub. No.: US 2026/0286218 A1
(43) Pub. Date: Sep. 24, 2026

(54) FLUORESCENT CONJUGATES

(71) Applicant: GlycoSurf, Inc., Salt Lake City, UT (US)

(72) Inventor: Ryan Stolley, Salt Lake City, UT (US)

(21) Appl. No.: 19/569,921

(22) Filed: Mar. 17, 2026

Related U.S. Application Data
(60) Provisional application No. 63/776,703, filed on Mar. 24, 2025.

(51) Int. Cl. C09K 11/06

(52) U.S. Cl. CPC C09K 11/06; C09K 2211/1022

(57) ABSTRACT

Described herein are fluorescent conjugates comprising a fluorophore attached to a glycosyl moiety. The fluorophore may comprise a conjugated pi bond system.

### RELATED APPLICATION(S)

This application claims priority to U.S. Provisional Application No. 63/776,703, filed on Mar. 24, 2025, which is hereby incorporated by reference in its entirety.

### STATEMENT OF GOVERNMENT INTEREST

This invention was made with government support under DE-SC0022403 awarded by the Department of Energy (DOE). The government has certain rights in the invention.

### TECHNICAL FIELD

The present disclosure relates to fluorescent conjugates comprising a fluorophore attached to a glycosyl moiety.

### INTRODUCTION

Glycolipids are natural amphiphiles and have gained particular interest due to their biodegradability, diversity, and bioactivity. For example, glycolipids may be used as metal chelators/extractants, surfactants, and/or antimicrobial agents.

### SUMMARY

In one aspect, a fluorescent conjugate is disclosed. The fluorescent conjugate may be a compound of formula (A):

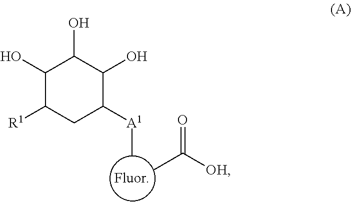

wherein:

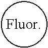

is a fluorophore comprising a conjugated pi bond system;
A¹ is O, S, or NH; and
R¹ is —CH₃, —CH₂OH, —CO₂H, or hydrogen.

The fluorescent conjugate may comprise a fluorophore attached to a glycosyl moiety,
the fluorophore comprising a conjugated pi bond system; and
the glycosyl moiety comprising a moiety of formula (I), (I′), or (I″):

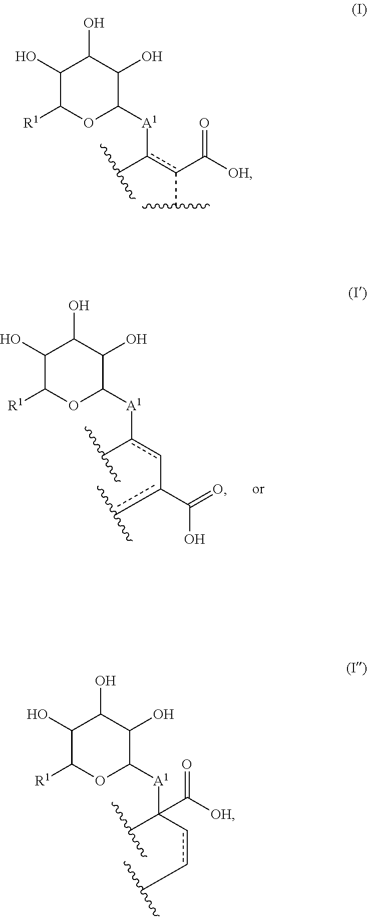

wherein:
A¹ is O, S, or NH;
R¹ is —CH₃, —CH₂OH, —CO₂H, or hydrogen;
[symbol] is an optional double bond; and
[symbol] is an optional single bond.

Other aspects and embodiments of the disclosure will become apparent in light of the following description.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### I. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents, and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an,” and “the” include plural references unless the context clearly dictates otherwise. The present disclosure also contemplates other embodiments “comprising,” “consisting of,” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March's Advanced Organic Chemistry, 5th Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

The term “alkoxy,” as used herein, refers to a group —O-alkyl. Representative examples of alkoxy include, but are not limited to, methoxy, ethoxy, propoxy, 2-propoxy, butoxy, and tert-butoxy.

The term “alkyl,” as used herein, means a straight or branched, saturated hydrocarbon chain. The term “lower alkyl” or “C₁₋₆alkyl” means a straight or branched chain hydrocarbon containing from 1 to 6 carbon atoms. The term “C₁₋₄alkyl” means a straight or branched chain hydrocarbon containing from 1 to 4 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

The term “alkenyl,” as used herein, means a straight or branched, hydrocarbon chain containing at least one carbon-carbon double bond.

The term “alkynyl,” as used herein, means a straight or branched, hydrocarbon chain containing at least one carbon-carbon triple bond.

The term “amide,” as used herein, means —C(O)NR— or —NRC(O)—, wherein R may be hydrogen, alkyl, cycloalkyl, aryl, heteroaryl, heterocycle, alkenyl, or heteroalkyl.

The term “amino,” as used herein, means —NRₓR_{y}, wherein Rₓ and R_{y} may be hydrogen, alkyl, cycloalkyl, aryl, heteroaryl, heterocycle, alkenyl, or heteroalkyl. In the case of an aminoalkyl group or any other moiety where amino appends together two other moieties, amino may be —NRₓ—, wherein Rₓ may be hydrogen, alkyl, cycloalkyl, aryl, heteroaryl, heterocycle, alkenyl, or heteroalkyl.

The term “aryl,” as used herein, refers to a phenyl or a phenyl appended to the parent molecular moiety and fused to a cycloalkane group (e.g., the aryl may be indan-4-yl), fused to a 6-membered arene group (i.e., the aryl is naphthyl), or fused to a non-aromatic heterocycle (e.g., the aryl may be benzo[d][1,3]dioxol-5-yl). The term “phenyl” is used when referring to a substituent and the term 6-membered arene is used when referring to a fused ring. The 6-membered arene is monocyclic (e.g., benzene or benzo). The aryl may be monocyclic (phenyl) or bicyclic (e.g., a 9- to 12-membered fused bicyclic system).

The term “cycloalkoxy,” as used herein, refers to a cycloalkyl group, as defined herein, appended to the parent molecular moiety through an oxygen atom.

The term “cycloalkyl” or “cycloalkane,” as used herein, refers to a saturated ring system containing all carbon atoms as ring members and zero double bonds. The term “cycloalkyl” is used herein to refer to a cycloalkane when present as a substituent. A cycloalkyl may be a monocyclic cycloalkyl (e.g., cyclopropyl), a fused bicyclic cycloalkyl (e.g., decahydronaphthalenyl), or a bridged cycloalkyl in which two non-adjacent atoms of a ring are linked by an alkylene bridge of 1, 2, 3, or 4 carbon atoms (e.g., bicyclo[2.2.1]heptanyl). Representative examples of cycloalkyl include, but are not limited to, cyclopropyl, cyclobutyl, cyclopentyl, cyclohexyl, cycloheptyl, cyclooctyl, cyclononyl, cyclodecyl, adamantyl, and bicyclo[1.1.1]pentanyl.

The term “cycloalkenyl” or “cycloalkene,” as used herein, means a non-aromatic monocyclic or multicyclic ring system containing all carbon atoms as ring members and at least one carbon-carbon double bond and preferably having from 5-10 carbon atoms per ring. The term “cycloalkenyl” is used herein to refer to a cycloalkene when present as a substituent. A cycloalkenyl may be a monocyclic cycloalkenyl (e.g., cyclopentenyl), a fused bicyclic cycloalkenyl (e.g., octahydronaphthalenyl), or a bridged cycloalkenyl in which two non-adjacent atoms of a ring are linked by an alkylene bridge of 1, 2, 3, or 4 carbon atoms (e.g., bicyclo[2.2.1]heptenyl). Exemplary monocyclic cycloalkenyl rings include cyclopentenyl, cyclohexenyl, or cycloheptenyl. Exemplary monocyclic cycloalkenyl rings include cyclopentenyl, cyclohexenyl, or cycloheptenyl.

The term “carbocyclyl” means a “cycloalkyl” or a “cycloalkenyl.” The term “carbocycle” means a “cycloalkane” or a “cycloalkene.” The term “carbocyclyl” refers to a “carbocycle” when present as a substituent.

The terms cycloalkylene and heterocyclylene refer to divalent groups derived from the base ring, i.e., cycloalkane, heterocycle. For purposes of illustration, examples of cycloalkylene and heterocyclylene include, respectively,

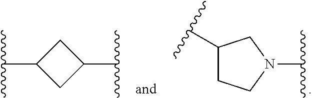 [SMILES: *C1CC(*)C1 ; *C1CCN(*)C1]

Cycloalkylene and heterocyclylene include a geminal divalent group such as 1,1-C₃₋₆cycloalkylene

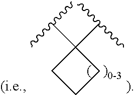

A further example is 1,1-cyclopropylene

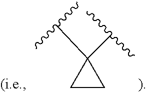 [SMILES: *C1(*)CC1]

The term “halogen” or “halo,” as used herein, means C₁, Br, I, or F.

The term “haloalkyl,” as used herein, means an alkyl group, as defined herein, in which one, two, three, four, five, six, seven, or eight hydrogen atoms are replaced by a halogen.

The term “haloalkoxy,” as used herein, means at least one haloalkyl group, as defined herein, is appended to the parent molecular moiety through an oxygen atom.

The term “halocycloalkyl,” as used herein, means a cycloalkyl group, as defined herein, in which one or more hydrogen atoms are replaced by a halogen.

The term “heteroalkyl,” as used herein, means an alkyl group, as defined herein, in which one or more of the carbon atoms has been replaced by a heteroatom selected from S, O, P, and N. Representative examples of heteroalkyls include, but are not limited to, alkyl ethers, secondary and tertiary alkyl amines, amides, and alkyl sulfides.

The term “heteroaryl,” as used herein, refers to an aromatic monocyclic heteroatom-containing ring (monocyclic heteroaryl) or a bicyclic ring system containing at least one monocyclic heteroaromatic ring (bicyclic heteroaryl). The term “heteroaryl” is used herein to refer to a heteroarene when present as a substituent. The monocyclic heteroaryls are five or six membered rings containing at least one heteroatom independently selected from the group consisting of N, O, and S (e.g., 1, 2, 3, or 4 heteroatoms independently selected from O, S, and N). The five-membered aromatic monocyclic rings have two double bonds, and the six-membered aromatic monocyclic rings have three double bonds. The bicyclic heteroaryl is an 8- to 12-membered ring system and includes a fused bicyclic heteroaromatic ring system (i.e., 10× electron system) such as a monocyclic heteroaryl ring fused to a 6-membered arene (e.g., quinolin-4-yl, indol-1-yl), a monocyclic heteroaryl ring fused to a monocyclic heteroarene (e.g., naphthyridinyl), and a phenyl fused to a monocyclic heteroarene (e.g., quinolin-5-yl, indol-4-yl). A bicyclic heteroaryl/heteroarene group includes a 9-membered fused bicyclic heteroaromatic ring system having four double bonds and at least one heteroatom contributing a lone electron pair to a fully aromatic 10π electron system, such as ring systems with a nitrogen atom at the ring junction (e.g., imidazopyridine) or a benzoxadiazolyl. A bicyclic heteroaryl also includes a fused bicyclic ring system composed of one heteroaromatic ring and one non-aromatic ring such as a monocyclic heteroaryl ring fused to a monocyclic carbocyclic ring (e.g., 6,7-dihydro-5H-cyclopenta[b]pyridinyl), or a monocyclic heteroaryl ring fused to a monocyclic heterocycle (e.g., 2,3-dihydrofuro[3,2-b]pyridinyl). The bicyclic heteroaryl is attached to the parent molecular moiety at an aromatic ring atom. Other representative examples of heteroaryl include, but are not limited to, indolyl (e.g., indol-1-yl, indol-2-yl, indol-4-yl), pyridinyl (including pyridin-2-yl, pyridin-3-yl, pyridin-4-yl), pyrimidinyl, pyrazinyl, pyridazinyl, pyrazolyl (e.g., pyrazol-4-yl), pyrrolyl, benzopyrazolyl, 1,2,3-triazolyl (e.g., triazol-4-yl), 1,3,4-thiadiazolyl, 1,2,4-thiadiazolyl, 1,3,4-oxadiazolyl, 1,2,4-oxadiazolyl, imidazolyl, thiazolyl (e.g., thiazol-4-yl), isothiazolyl, thienyl, benzimidazolyl (e.g., benzimidazol-5-yl), benzothiazolyl, benzoxazolyl, benzoxadiazolyl, benzothienyl, benzofuranyl, isobenzofuranyl, furanyl, oxazolyl, isoxazolyl, purinyl, isoindolyl, quinoxalinyl, indazolyl (e.g., indazol-4-yl, indazol-5-yl), quinazolinyl, 1,2,4-triazinyl, 1,3,5-triazinyl, isoquinolinyl, quinolinyl, imidazo[1,2-a]pyridinyl (e.g., imidazo[1,2-a]pyridin-6-yl), naphthyridinyl, pyridoimidazolyl, thiazolo[5,4-b]pyridin-2-yl, and thiazolo[5,4-d]pyrimidin-2-yl.

The term “heterocycle” or “heterocyclic,” as used herein, means a monocyclic heterocycle, a bicyclic heterocycle, or a tricyclic heterocycle. The term “heterocyclyl” is used herein to refer to a heterocycle when present as a substituent. The monocyclic heterocycle is a three-, four-, five-, six-, seven-, or eight-membered ring containing at least one heteroatom independently selected from the group consisting of O, N, and S. The three- or four-membered ring contains zero or one double bond, and one heteroatom selected from the group consisting of O, N, and S. The five-membered ring contains zero or one double bond and one, two, or three heteroatoms selected from the group consisting of O, N, and S. The six-membered ring contains zero, one, or two double bonds and one, two, or three heteroatoms selected from the group consisting of O, N, and S. The seven- and eight-membered rings contain zero, one, two, or three double bonds and one, two, or three heteroatoms selected from the group consisting of O, N, and S. Representative examples of monocyclic heterocyclyls include, but are not limited to, azetidinyl, azepanyl, aziridinyl, diazepanyl, 1,3-dioxanyl, 1,3-dioxolanyl, 1,3-dithiolanyl, 1,3-dithianyl, imidazolinyl, imidazolidinyl, isothiazolinyl, isothiazolidinyl, isoxazolinyl, isoxazolidinyl, morpholinyl, 2-oxo-3-piperidinyl, 2-oxoazepan-3-yl, oxadiazolinyl, oxadiazolidinyl, oxazolinyl, oxazolidinyl, oxetanyl, oxepanyl, oxocanyl, piperazinyl, piperidinyl, pyranyl, pyrazolinyl, pyrazolidinyl, pyrrolinyl, pyrrolidinyl, tetrahydrofuranyl, tetrahydropyranyl, tetrahydropyridinyl, tetrahydrothienyl, thiadiazolinyl, thiadiazolidinyl, 1,2-thiazinanyl, 1,3-thiazinanyl, thiazolinyl, thiazolidinyl, thiomorpholinyl, 1,1-dioxidothiomorpholinyl(thiomorpholine sulfone), thiopyranyl, and trithianyl. The bicyclic heterocycle is a monocyclic heterocycle fused to a 6-membered arene, or a monocyclic heterocycle fused to a monocyclic cycloalkane, or a monocyclic heterocycle fused to a monocyclic cycloalkene, or a monocyclic heterocycle fused to a monocyclic heterocycle, or a monocyclic heterocycle fused to a monocyclic heteroarene, or a spiro heterocycle group, or a bridged monocyclic heterocycle ring system in which two non-adjacent atoms of the ring are linked by an alkylene bridge of 1, 2, 3, or 4 carbon atoms, or an alkenylene bridge of two, three, or four carbon atoms. The bicyclic heterocyclyl is attached to the parent molecular moiety at a non-aromatic ring atom (e.g., indolin-1-yl). Representative examples of bicyclic heterocyclyls include, but are not limited to, chroman-4-yl, 2,3-dihydrobenzofuran-2-yl, 2,3-dihydrobenzothien-2-yl, 1,2,3,4-tetrahydroisoquinolin-2-yl, 2-azaspiro[3.3]heptan-2-yl, 2-oxa-6-azaspiro[3.3]heptan-6-yl, azabicyclo[2.2.1]heptyl (including 2-azabicyclo[2.2.1]hept-2-yl), azabicyclo[3.1.0]hexanyl (including 3-azabicyclo[3.1.0]hexan-3-yl), 2,3-dihydro-1H-indol-1-yl, isoindolin-2-yl, octahydrocyclopenta[c]pyrrolyl, octahydropyrrolopyridinyl, tetrahydroisoquinolinyl, 7-oxabicyclo[2.2.1]heptanyl, hexahydro-2H-cyclopenta[b]furanyl, 2-oxaspiro[3.3]heptanyl, 3-oxaspiro[5.5]undecanyl, 6-oxaspiro[2.5]octan-1-yl, and 3-oxabicyclo[3.1.0]hexan-6-yl. Tricyclic heterocycles are exemplified by a bicyclic heterocycle fused to a 6-membered arene, or a bicyclic heterocycle fused to a monocyclic cycloalkane, or a bicyclic heterocycle fused to a monocyclic cycloalkene, or a bicyclic heterocycle fused to a monocyclic heterocycle, or a bicyclic heterocycle in which two non-adjacent atoms of the bicyclic ring are linked by an alkylene bridge of 1, 2, 3, or 4 carbon atoms, or an alkenylene bridge of two, three, or four carbon atoms. Examples of tricyclic heterocycles include, but are not limited to, octahydro-2,5-epoxypentalene, hexahydro-2H-2,5-methanocyclopenta[b]furan, hexahydro-1H-1,4-methanocyclopenta[c]furan, aza-adamantane (1-azatricyclo[3.3.1.13,7]decane), and oxa-adamantane (2-oxatricyclo[3.3.1.13,7]decane). The monocyclic, bicyclic, and tricyclic heterocyclyls are connected to the parent molecular moiety at a non-aromatic ring atom.

The term “hydroxyl” or “hydroxy,” as used herein, means an —OH group.

The term “hydroxyalkyl,” as used herein, means at least one —OH group is appended to the parent molecular moiety through an alkylene group, as defined herein.

The term “nitrile,” as used herein, means any organic compound that has a —C≡N functional group.

Terms such as “alkyl,” “cycloalkyl,” “alkylene,” etc. may be preceded by a designation indicating the number of atoms present in the group in a particular instance (e.g., “C₁₋₄alkyl,” “C₃₋₆cycloalkyl,” “C₁₋₄alkylene”). These designations are used as generally understood by those skilled in the art. For example, the representation “C” followed by a subscripted number indicates the number of carbon atoms present in the group that follows. Thus, “C₃alkyl” is an alkyl group with three carbon atoms (i.e., n-propyl, isopropyl). Where a range is given, as in “C₁₋₄,” the members of the group that follows may have any number of carbon atoms falling within the recited range. A “C₁₋₄alkyl,” for example, is an alkyl group having from 1 to 4 carbon atoms, however arranged (i.e., straight chain or branched).

The term “substituted” refers to a group that may be further substituted with one or more non-hydrogen substituent groups. Substituent groups include, but are not limited to, halogen, ═O (oxo), ═S (thioxo), cyano, nitro, fluoroalkyl, alkoxyfluoroalkyl, fluoroalkoxy, alkyl, alkenyl, alkynyl, haloalkyl, haloalkoxy, heteroalkyl, cycloalkyl, cycloalkenyl, aryl, heteroaryl, heterocycle, cycloalkylalkyl, heteroarylalkyl, arylalkyl, hydroxy, hydroxyalkyl, alkoxy, alkoxyalkyl, alkylene, aryloxy, phenoxy, benzyloxy, amino, alkylamino, acylamino, aminoalkyl, arylamino, sulfonylamino, sulfinylamino, sulfonyl, alkylsulfonyl, arylsulfonyl, aminosulfonyl, sulfinyl, —COOH, ketone, amide, carbamate, and acyl.

The term “leaving group” refers to an atom (or a group of atoms) with electron-withdrawing ability that can be displaced as a stable species, taking with it the bonding electrons. Examples of suitable leaving groups include halides (e.g., Br, Cl, I), sulfonate esters (e.g., triflate, mesylate, tosylate, and brosylate), and nitrophenols.

The term “protecting group” refers to a temporary chemical modification of a functional group to prevent it from reacting under specific reaction conditions, allowing other parts of the molecule to be selectively modified.

### Abbreviations

Bn is benzyl;
Ac is acetyl or acyl;
Et is ethyl;
Me is methyl;
Pd/C is palladium on carbon;
LG is leaving group;
PG is protecting group;
EtOAc is ethyl acetate;
DCM is dichloromethane;
NaOMe is sodium methoxide;
BF₃·Et₂O is boron trifluoride diethyl ether;
Pd/C is palladium on carbon;
THF is tetrahydrofuran;
NMR is nuclear magnetic resonance;
LRMS is low resolution mass spectrometry;
ESI is electron spray ionization;
TLC is thin-layer chromatography;
4 Å MS is 4 angstrom molecular sieves;
eq. or equiv. is equivalents;
min or min. is minute(s); and
h or hr. is hour(s).

### II. Fluorescent Conjugates

In one aspect, exemplary fluorescent conjugates of the present disclosure may be represented by formula (A):

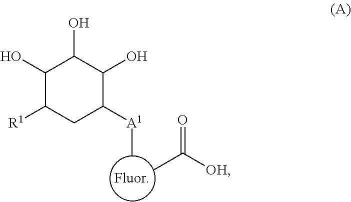

wherein:

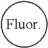

is a fluorophore; and
R¹ is —CH₃, —CH₂OH, —CO₂H, or hydrogen.

As used herein, the term “fluorophore” means a molecule or moiety that is capable of absorbing energy at a wavelength range and releasing energy at a wavelength range other than the absorbance range. In certain embodiments, the fluorophore is a molecule that is capable of absorbing energy at about 250 nm to about 900 nm and releasing energy at a wavelength range of about 260 nm to about 910 nm. The term “excitation wavelength” refers to the range of wavelengths at which a fluorophore absorbs energy. The term “emission wavelength” refers to the range of wavelengths that the fluorophore releases energy or fluoresces. As used herein, a “fluorophore” includes a complete fluorescent molecule or a fluorescent moiety thereof that retains the ability to absorb and emit light when incorporated into a larger molecular structure.

Exemplary fluorophores comprise a conjugated pi bond system. As used herein, the term “conjugated pi bond system” refers to a system of connected p orbitals with delocalized electrons in a molecule, which in general lowers the overall energy of the molecule and increases stability. A conjugated pi bond system is conventionally represented as having alternating single and multiple bonds. Lone pairs, radicals or carbenium ions may be part of the system, which may be cyclic, acyclic, linear or mixed. Conjugation is the overlap of one p orbital with another across an intervening s bond (in transition metals d orbitals may be involved). A conjugated system has a region of overlapping p orbitals, bridging the inter adjacent locations that simple diagrams illustrate as not having a p bond. They allow a delocalization of p electrons across all the adjacent aligned p orbitals. The p electrons do not belong to a single bond or atom, but rather to a group of atoms. In some instances, the conjugated pi bond system of exemplary fluorophores may be bound to a metal. Such metal binding may modulate the excitation or emission properties of the fluorophore.

Exemplary fluorophores may include dyes, such as compounds of the formula Ar—(CH═CH)₁₋₄—(CH═CH)₀₋₁—Ar, wherein Ar is an aryl or heteroaryl group and wherein each Ar includes a quaternary nitrogen or a nitrogen capable of being quaternized through resonance. Examples of such aryl or heteroaryl groups include dimethyl-aminophenyl, imidazole, pyridine, pyrrole, quinoline, thiazole, and indole, each optionally substituted. The fluorophore may be inherently fluorescent or may exhibit a change in fluorescence intensity, wavelength, or quantum yield upon conjugation, aggregation, environmental changes, or interaction with another moiety, including but not limited to biological compounds. Exemplary fluorophores may contain substituents that alter the solubility, spectral properties or physical properties of the fluorophore. Various fluorophores are known to those skilled in the art and include benzofurans, quinolines, quinazolinones, indoles, benzazoles, borapolyazaindacene, and xanthenes including fluorescein, rhodamine, and rhodol, as well as other fluorophores described in Richard P. Haugland's The Handbook, A Guide to Fluorescent Probes and Labeling Technologies (10th edition, 2005), which describes numerous exemplary fluorophores. For example, fluorophores include fluorescein, Texas Red, DAPI (4′,6-diamidino-2-phenylindole), propidium iodide (PI), acridine orange, Alexa fluors (e.g., Alexa 350, Alexa 405, and Alexa 488), cyanine dyes (e.g., Cy3, Cy5, and Cy7), ethidium bromide, fluorescein, BODIPY, rhodol, Rox, 5-carboxyfluorescein, 6-carboxyfluorescein, an anthracene, 2-amino-4-methoxynapthalene, a phenalenone, an acridone, fluorinated xanthene derivatives, α-naphtol, β-napthol, 1-hydroxypyrene, coumarins (e.g., coumarin, 7-amino-4-methylcoumarin (AMC), and 7-amino-4-trifluoromethylcoumarin (AFC)), and rhodamines (e.g., tetramethylrhodamine, rhodamine-110, carboxyrhodamine, cresyl violet, and resorufin).

In another aspect, exemplary fluorescent conjugates of the present disclosure may be fluorescent conjugates comprising:
a fluorophore attached to a glycosyl moiety,
   the fluorophore comprising a conjugated pi bond system; and
   the glycosyl moiety comprising a moiety of formula (I), (I′), or (I″):

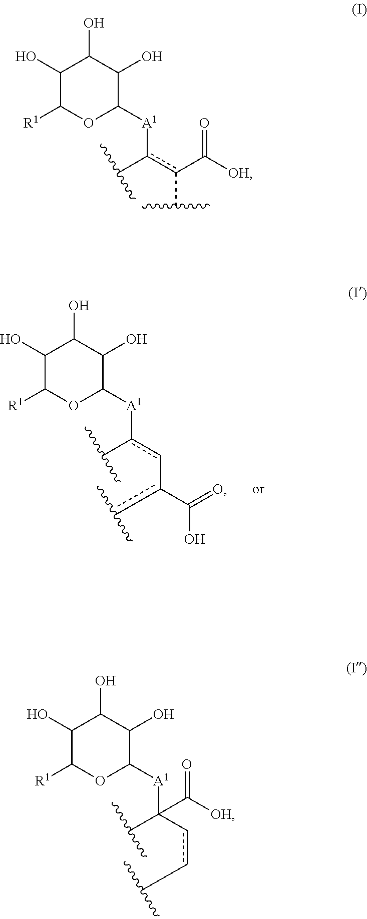

wherein:
A¹ is O, S, or NH;
R¹ is —CH₃, —CH₂OH, —CO₂H, or hydrogen;
[symbol] is an optional double bond; and
[symbol] is an optional single bond.

In the following, numbered embodiments of the fluorescent conjugates are disclosed. The first embodiment is denoted E1, and subsequent embodiments are denoted E2, E3, E4, E5, etc.

E1. A fluorescent conjugate, wherein the fluorescent conjugate is a compound of formula (A):

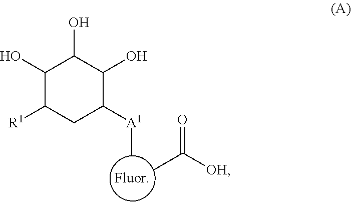

wherein:

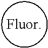

is a fluorophore comprising a conjugated pi bond system;
A¹ is O, S, or NH; and
R¹ is —CH₃, —CH₂OH, —CO₂H, or hydrogen.

E2. A fluorescent conjugate, comprising:

a fluorophore attached to a glycosyl moiety,
the fluorophore comprising a conjugated pi bond system; and
the glycosyl moiety comprising a moiety of formula (I), (I′), or (I″):

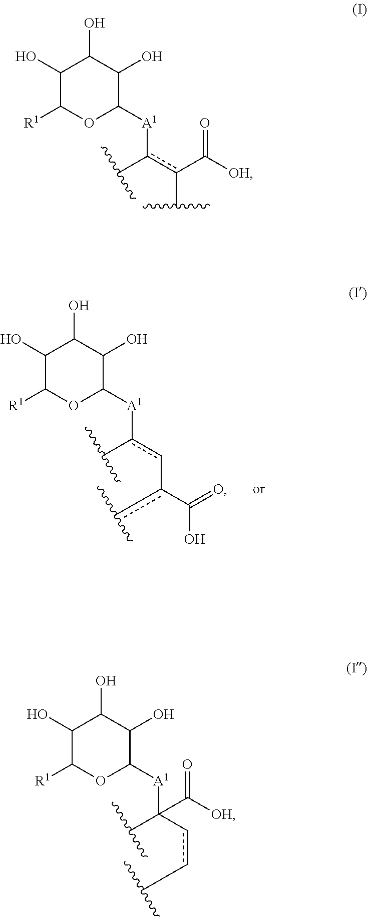

wherein:
A¹ is O, S, or NH;
R¹ is —CH₃, —CH₂OH, —CO₂H, or hydrogen;
[symbol] is an optional double bond; and
[symbol] is an optional single bond.

E3. The fluorescent conjugate of E2, the glycosyl moiety comprising at least one pi bond in conjugation with the conjugated pi bond system of the fluorophore.

E4. The fluorescent conjugate of E2 or E3, the glycosyl moiety comprising the moiety of formula (I).

E5. The fluorescent conjugate of any one of E2-E4, wherein the moiety of formula (I) is a moiety of formula (I-a) or (I-b):

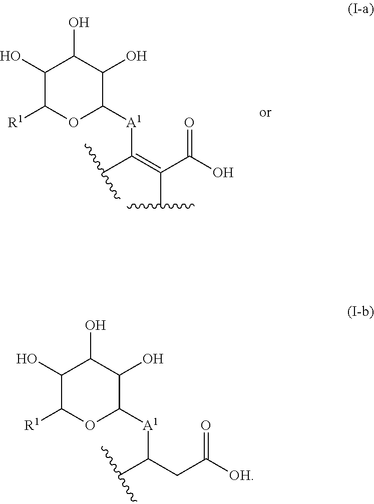

E6. The fluorescent conjugate of E5, the glycosyl moiety comprising the moiety of formula (I-a).

E7. The fluorescent conjugate of any one of E2-E6, the glycosyl moiety comprising:

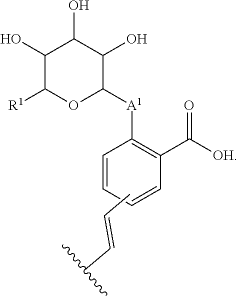

E8. The fluorescent conjugate of E5, the glycosyl moiety comprising the moiety of formula (I-b).

E9. The fluorescent conjugate of any one of E2-E5 or E8, the glycosyl moiety comprising:

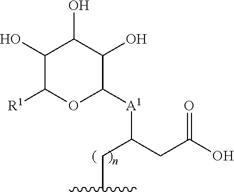

wherein n is 1 to 10.

E10. The fluorescent conjugate of E2 or E3, the glycosyl moiety comprising the moiety of formula (I′).

E11. The fluorescent conjugate of E10, wherein the moiety of formula (I′) is a moiety of formula (I′-a) or (I′-b):

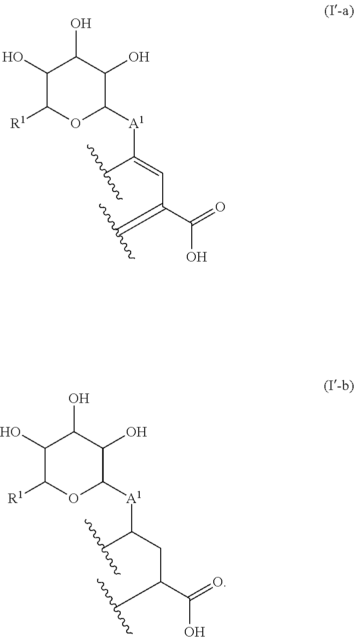

E12. The fluorescent conjugate of E2 or E3, the glycosyl moiety comprising the moiety of formula (I″).

E13. The fluorescent conjugate of E12, wherein the moiety of formula (I″) is a moiety of formula (I″-a) or (I″-b):

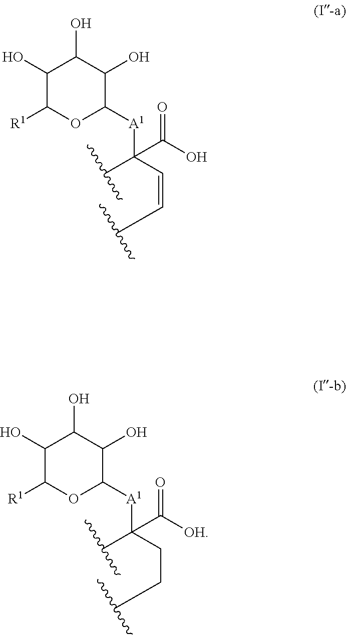

E14. The fluorescent conjugate of any one of E1-E13, wherein the fluorophore is a fluorescein, a rhodamine, a cyanine, a xanthene, a quinoline, a boron-dipyrromethene (BODIPY), a coumarin dye, an Alexa Fluor dye, carotene, a non-metalated polypyridine, or a metalated polypyridine.

E15. The fluorescent conjugate of E1 or E2, wherein the fluorescent conjugate is:

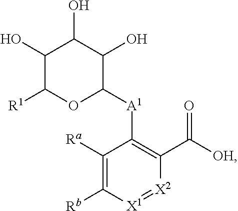

wherein:
A¹ is O, S, or NH;
R^{a} and R^{b}, together with the atoms to which they are attached, form a 6- to 12-membered arene, a 5- to 12-membered partially saturated carbocycle, a 5-14-membered heteroarene, or a 5-14-membered partially saturated heterocycle, each optionally substituted with 1-5 R^{X}; or, alternatively,
R^{a} and R^{b} are each independently hydrogen, C₁₋₆alkyl, C₂₋₆alkenyl, C₂₋₆alkynyl, C₁₋₄haloalkyl, halogen, —CN, oxo, —OR^{10a}, G¹⁰, —OG¹⁰, —C(O)R^{10b}, —CO₂R^{10b}, —SO₃X′, —CO₂X′, —SO₃R^{10b}, —SO₂R^{10b}, —N(R^{10b})₂, —CO₂N(R^{10b})₂, -L¹-CN, -L¹-G¹⁰, -L¹-OR^{10a}, -L¹-OG¹⁰, -L¹-CO₂R^{10b}, -L¹-SO₃X′, -L¹-C(O)R^{10b}, -L¹-SO₃R^{10b}, -L¹-SO₂R^{10b}, -L¹-N(R^{10b})₂, or -L¹-CO₂N(R^{10b})₂;
X¹ is C—R^{c} or N;
X² is C—R^{d} or N;
R^{c} and R^{d} are each independently hydrogen, C₁₋₆alkyl, C₂₋₆alkenyl, C₂₋₆alkynyl, C₁₋₄haloalkyl, halogen, —CN, oxo, —OR^{10a}, G¹⁰, —OG¹⁰, —C(O)R^{10b}, —CO₂R^{10b}, —SO₃X′, —CO₂X′, —SO₃R^{10b}, —SO₂R^{10b}, —N(R^{10b})₂, —CO₂N(R^{10b})₂, -L¹-CN, -L¹-G¹⁰, -L¹-OR^{10a}, -L¹-OG¹⁰, -L¹-CO₂R^{10b}, -L¹-SO₃X′, -L¹-C(O)R^{10b}, -L¹-SO₃R^{10b}, -L¹-SO₂R^{10b}, -L¹-N(R^{10b})₂, or L¹-CO₂N(R^{10b})₂; or, alternatively,
R^{c} and R^{b} and/or R^{c} and R^{d}, together with the atoms to which they are attached, form a 6- to 12-membered arene, a 5- to 12-membered partially saturated carbocycle, a 5-14-membered heteroarene, or a 5-14-membered partially saturated heterocycle, each optionally substituted with 1-5 R^{X};
R^{X}, at each occurrence, is independently C₁₋₆alkyl, C₂₋₆alkenyl, C₂₋₆alkynyl, C₁₋₄ fluoroalkyl, halogen, —CN, oxo, G¹⁰, —OR^{10a}, -OG¹⁰, —C(O)R^{10b}, —CO₂R^{10b}, —SO₃X′, —CO₂X′, —SO₃R^{10b}, —SO₂R^{10b}, —N(R^{10b})₂, —CO₂N(R^{10b})₂, -L¹-CN, -L¹-G¹⁰, -L¹-OR^{10a}, -L¹-OG¹⁰, -L¹-CO₂R^{10b}, -L¹-C(O)R^{10b}, -L¹-SO₃X′, L¹-CO₂X′, L¹-SO₃R^{10b}, -L¹-SO₂R^{10b}, -L¹-N(R^{10b})₂, or -L¹-CO₂N(R^{10b})₂;
R^{10a}, at each occurrence, is independently hydrogen, C₁₋₆alkyl, or C₁₋₂haloalkyl;
R^{10b}, at each occurrence, is independently hydrogen or C₁₋₆alkyl;
G¹⁰, at each occurrence, is independently C₃₋₆carbocyclyl, phenyl, a 4- to 6-membered heterocyclyl, or a 5- to 6-membered heteroaryl, wherein G¹⁰ is optionally substituted with 1-4 substituents independently selected from the group consisting of C₁₋₄alkyl, C₁₋₂haloalkyl, halogen, —CN, —OC₁₋₄alkyl, —OC₁₋₂haloalkyl, —SO₃X′, —CO₂C₁₋₄alkyl, and —CO₂X′;
X′ is a monovalent anion; and
L¹, at each occurrence, is a C₁₋₆alkylene, C₂₋₆alkenylene, or C₂₋₆alkynylene.

E16. The fluorescent conjugate of E15, wherein R^{a} and R^{b}, together with the atoms to which they are attached, form the 6- to 12-membered arene or the 5-14-membered heteroarene.

E17. The fluorescent conjugate of E15 or E16, wherein X¹ is C—R^{c} or N and X² is C—R^{d}.

E18. The fluorescent conjugate of E15 or E16, wherein X¹ is C—R^{c} and X² is C—R^{d} or N.

E19. The fluorescent conjugate of any one of E15-E18, wherein C—R^{c} is C—H.

E20. The fluorescent conjugate of any one of E15-E19, wherein C—R^{d} is C—H.

E21. The fluorescent conjugate of any one of E1-E20, wherein the fluorescent conjugate is:

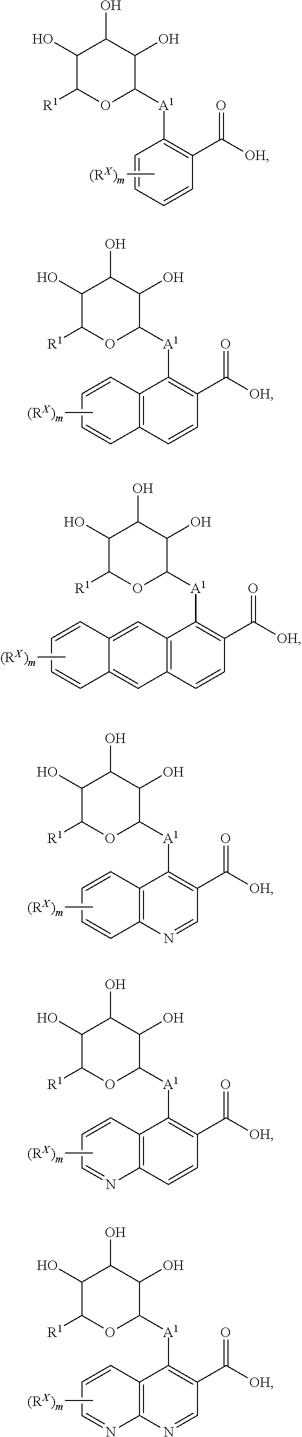

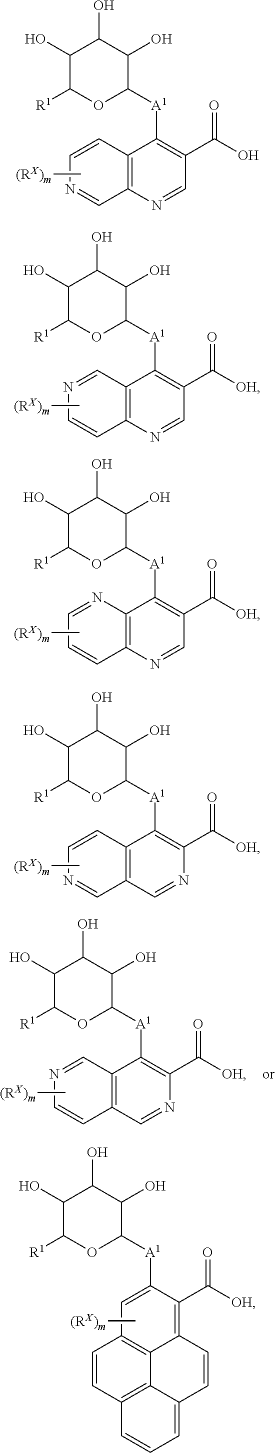

wherein m is 0, 1, or 2.

E22. The fluorescent conjugate of any one of E1-E21, wherein R¹ is —CH₃.

E23. The fluorescent conjugate of any one of E1-E22, wherein:

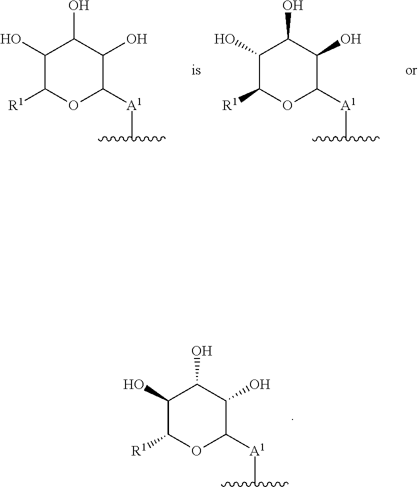

E24. The fluorescent conjugate of any one of E1-E23, wherein A¹ is O.

E25. The fluorescent conjugate of any one of E1-E24, wherein a metal is bound to the conjugated pi system.

### A. Salts

The disclosed compounds may exist as salts, such as pharmaceutically acceptable salts. The term “pharmaceutically acceptable salt” refers to salts or zwitterions of the compounds which are water or oil-soluble or dispersible, suitable for administration to a subject (e.g., treatment of disorders) without undue toxicity, irritation, and allergic response, commensurate with a reasonable benefit/risk ratio and effective for their intended use. The salts may be prepared during the final isolation and purification of the compounds or separately by reacting an amino group of the compounds with a suitable acid. For example, a fluorescent conjugate of formula (A) may be dissolved in a suitable solvent and treated with at least one equivalent of an acid, like hydrochloric acid. The resulting salt may precipitate out and be isolated by filtration and dried under reduced pressure. Alternatively, the solvent and excess acid may be removed under reduced pressure to provide a salt. Representative salts include acetate, adipate, alginate, citrate, aspartate, benzoate, benzenesulfonate, bisulfate, butyrate, camphorate, camphorsulfonate, digluconate, glycerophosphate, hemisulfate, heptanoate, hexanoate, formate, isethionate, fumarate, lactate, maleate, methanesulfonate, naphthylenesulfonate, nicotinate, oxalate, pamoate, pectinate, persulfate, 3-phenylpropionate, picrate, oxalate, maleate, pivalate, propionate, succinate, tartrate, trichloroacetate, trifluoroacetate, glutamate, para-toluenesulfonate, undecanoate, hydrochloric, hydrobromic, sulfuric, phosphoric and the like. The amino groups of the compounds may also be quaternized with alkyl chlorides, bromides, and iodides such as methyl, ethyl, propyl, isopropyl, butyl, lauryl, myristyl, stearyl and the like.

Basic addition salts may be prepared during the final isolation and purification of the disclosed compounds by reaction of a carboxyl group with a suitable base such as the hydroxide, carbonate, or bicarbonate of a metal cation such as lithium, sodium, potassium, calcium, magnesium, or aluminum, or an organic primary, secondary, or tertiary amine. Quaternary amine salts may be prepared, such as those derived from methylamine, dimethylamine, trimethylamine, triethylamine, diethylamine, ethylamine, tributylamine, pyridine, N,N-dimethylaniline, N-methylpiperidine, N-methylmorpholine, dicyclohexylamine, procaine, dibenzylamine, N,N-dibenzylphenethylamine, 1-ephenamine and N,N′-dibenzylethylenediamine, ethylenediamine, ethanolamine, diethanolamine, piperidine, piperazine, and the like.

In some instances, the disclosed compounds may exist as pharmaceutically acceptable salts. The term “pharmaceutically acceptable salt” refers to salts or zwitterions of the compounds which are water or oil-soluble or dispersible, suitable for treatment of disorders without undue toxicity, irritation, and allergic response, commensurate with a reasonable benefit/risk ratio and effective for their intended use.

### B. General Syntheses

In various instances, fluorescent conjugates described herein may be synthesized as shown in the following schemes.

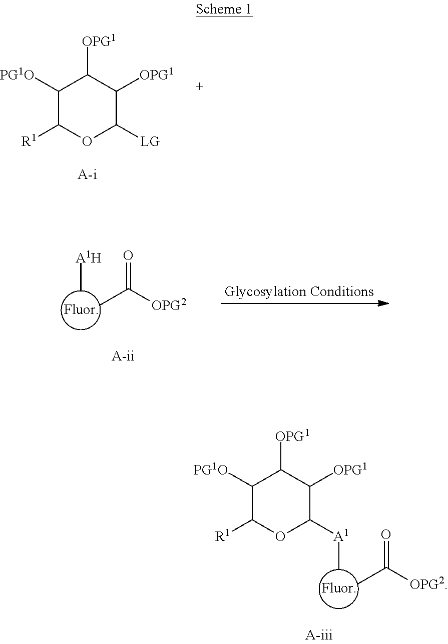

As shown in Scheme 1, glycosyl compounds of formula A-I, which contain a leaving group may be reacted with fluorophore compounds of formula A-ii under suitable glycosylation conditions (e.g., in the presence of BF₃·Et₂O and 4 Å MS) to provide compounds of formula A-iii.

In general, glycosylation may be carried out using standard procedures wherein the fluorophore donor comprises a hydroxyl (—OH), thiol (—SH), or amino (—NH2) functional group that is glycosylated to the appropriate saccharide via Lewis/Protic acid promotion utilizing appropriate protecting group application. The promoter used for glycosylation may vary. For instance, the selection of the promoter may be based on the leaving group (LG), reactivity of donor, and stereochemistry. Exemplary promoters include protic acids (e.g., sulfonic acids, HBF₄, H⁺-exchange resins), Lewis acids (e.g., BF₃, Bi³⁺, In³⁺), and, where appropriate, oxidants (e.g., N-iodosuccinimide (NIS), Ag-salts).

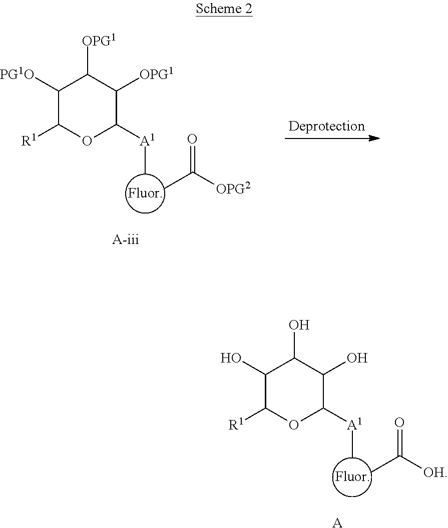

As shown in Scheme 2, compounds of formula A-iii may be subjected to suitable PG1 and PG2 deprotection conditions, thereby removing the PG1 and PG2 groups to yield compounds of formula A. In some instances, PG1 and PG2 group deprotection may occur simultaneously.

In other instances, PG1 and PG2 group deprotection may occur sequentially. To remove the PG1 groups, compounds of formula A-iii or PG2-deprotected compounds of formula A-iii may be subjected to suitable PG1 deprotection conditions. For example, when each PG1 is acetyl (Ac), compounds of formula A-iii or PG2-deprotected compounds of formula A-iii may be subjected to suitable basic conditions (e.g., NaOMe in MeOH). To remove the PG2 group, compounds of formula A-iii or PG1-deprotected compounds of formula A-iii may be subjected to suitable PG2 deprotection conditions. For example, when PG2 is benzyl (Bn), the compounds of formula A-iii or PG1-deprotected compounds of formula A-iii may be subjected to Pd/C-catalyzed hydrogenation conditions.

The compounds and intermediates may be isolated and purified by methods well-known to those skilled in the art of organic synthesis. Examples of conventional methods for isolating and purifying compounds can include, but are not limited to, chromatography on solid supports such as silica gel, alumina, or silica derivatized with alkylsilane groups, by recrystallization at high or low temperature with an optional pretreatment with activated carbon, thin-layer chromatography, distillation at various pressures, sublimation under vacuum, and trituration, as described for instance in “Vogel's Textbook of Practical Organic Chemistry,” 5th edition (1989), by Furniss, Hannaford, Smith, and Tatchell, pub. Longman Scientific & Technical, Essex CM20 2JE, England.

A disclosed compound may have at least one basic nitrogen whereby the compound can be treated with an acid to form a desired salt. For example, a compound may be reacted with an acid at or above room temperature to provide the desired salt, which is deposited, and collected by filtration after cooling. Examples of acids suitable for the reaction include, but are not limited to tartaric acid, lactic acid, succinic acid, as well as mandelic, atrolactic, methanesulfonic, ethanesulfonic, toluenesulfonic, naphthalenesulfonic, benzenesulfonic, carbonic, fumaric, maleic, gluconic, acetic, propionic, salicylic, hydrochloric, hydrobromic, phosphoric, sulfuric, citric, hydroxybutyric, camphorsulfonic, malic, phenylacetic, aspartic, or glutamic acid, and the like.

Reaction conditions and reaction times for each individual step can vary depending on the particular reactants employed and substituents present in the reactants used. Specific procedures are provided in the Examples section. Reactions can be worked up in the conventional manner, e.g., by eliminating the solvent from the residue and further purified according to methodologies generally known in the art such as, but not limited to, crystallization, distillation, extraction, trituration, and chromatography. Unless otherwise described, the starting materials and reagents are either commercially available or can be prepared by one skilled in the art from commercially available materials using methods described in the chemical literature. Starting materials, if not commercially available, can be prepared by procedures selected from standard organic chemical techniques, techniques that are analogous to the synthesis of known, structurally similar compounds, or techniques that are analogous to the above-described schemes or the procedures described in the synthetic examples section.

Routine experimentations, including appropriate manipulation of the reaction conditions, reagents and sequence of the synthetic route, protection of any chemical functionality that cannot be compatible with the reaction conditions, and deprotection at a suitable point in the reaction sequence of the method are included in the scope of the invention. Suitable protecting groups and the methods for protecting and deprotecting different substituents using such suitable protecting groups are well known to those skilled in the art; examples of which can be found in P G M Wuts and T W Greene, in Greene's book titled Protective Groups in Organic Synthesis (4th ed.), John Wiley & Sons, NY (2006), which is incorporated herein by reference in its entirety. Synthesis of the compounds of the invention can be accomplished by methods analogous to those described in the synthetic schemes described hereinabove and in specific examples.

When an optically active form of a disclosed compound is required, it can be obtained by carrying out one of the procedures described herein using an optically active starting material (prepared, for example, by asymmetric induction of a suitable reaction step), or by resolution of a mixture of the stereoisomers of the compound or intermediates using a standard procedure (such as chromatographic separation, recrystallization or enzymatic resolution).

Similarly, when a pure geometric isomer of a compound is required, it can be obtained by carrying out one of the above procedures using a pure geometric isomer as a starting material, or by resolution of a mixture of the geometric isomers of the compound or intermediates using a standard procedure such as chromatographic separation.

It can be appreciated that the synthetic schemes and specific examples as described are illustrative and are not to be read as limiting the scope of the invention as it is defined in the appended claims. All alternatives, modifications, and equivalents of the synthetic methods and specific examples are included within the scope of the claims.

### III. Applications

Exemplary fluorescent conjugates may be used as metal chelators/extractants, surfactants, and/or antimicrobial agents. In some instances, exemplary fluorescent conjugates may be used as a surfactant in various products, such as detergents, wetting agents, emulsifiers, foaming agents, and dispersants.

### Examples

Without limiting the scope of the instant disclosure, experimental examples of embodiments discussed above were prepared and the results are discussed below.

### Synthesis of Example Fluorescent Conjugates

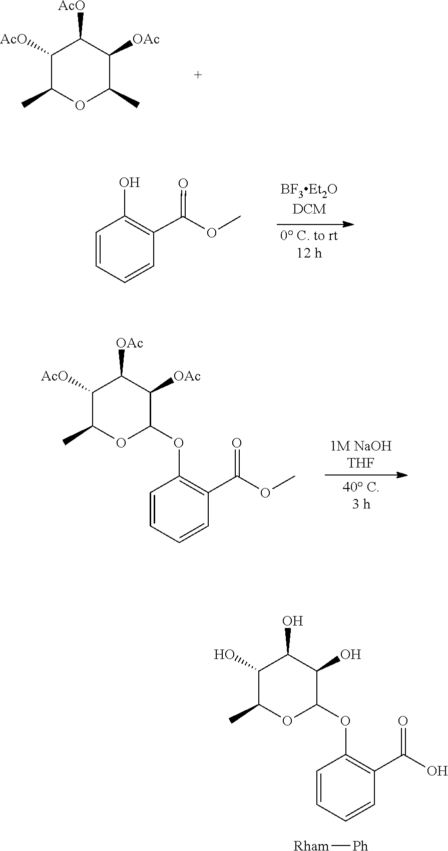

2-(((3R,4R,5R,6S)-3,4,5-Trihydroxy-6-methyltetrahydro-2H-pyran-2-yl)oxy)benzoic acid (“Rham-Ph”). Rhamnose peracetate (33 g, 100 mmol, 1.3 equiv) and methyl salicylate (10 mL, 76.9 mmol, 1.0 equiv) were dissolved in dry dichloromethane (150 mL) under an N₂ atmosphere and cooled to 0° C. To this solution was then added BF₃·Et₂O (12.5 mL, 76.9 mmol, 1.3 equiv) slowly and the resulting solution was allowed to warm to rt overnight. This solution was then added to a separatory funnel and washed sequentially with water, saturated NaHCO₃, and brine. The organic phase was then dried over Na₂SO₄ and condensed via rotary evaporation. The product was purified by column chromatography (10% to 75% EtOAc/Hexane) affording the product as a straw-colored resin. 22.5 g, 69%. The purified product was dissolved in THF and 1M NaOH (5.0 equiv) was added with stirring. The solution was warmed to 40° C. and stirred for 3 h. The solution was cooled to rt and neutralized with H⁺-exchange resin. The solution was filtered and condensed to dryness on rotary evaporation and further dried under high vacuum to afford the title compound as a straw-colored resin. 14.5 g, 96%, ¹H NMR (300 MHZ, CDCl₃) δ: 1.11 (d, 3H), 3.69-3.77 (m, 3H), 4.16 (dd, 1H), 4.51 (br s, 1H), 4.77 (br s, 1H), 4.90 (br s, 1H), 5.80 (d, 1H), 7.61 (d, 1H), 7.74-7.7.80 (m, 3H), 8.28 (d, 1H), 8.49 (d, 1H), 11.9-12.05 (br s, 1H). ¹³C NMR (300 MHz, CDCl₃) δ: 17.0, 70.5, 73.4, 73.9, 74.2, 101.9, 109.3, 120.6, 122.0, 123.1, 124.7, 126.3, 127.3, 129.0, 139.8, 157.8, 171.9. LRMS: m/z: [M+Na] calc'd: C₁₃H₁₅NaO₇:306.1 found: 305.9.

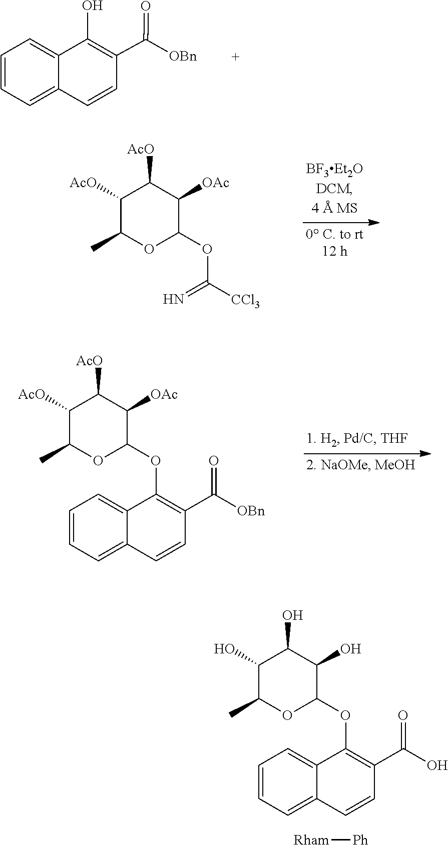

1-(((3R,4R,5R,6S)-3,4,5-Trihydroxy-6-methyltetrahydro-2H-pyran-2-yl)oxy)-2-naphthoic acid (“Rham-1-Naph”). Benzyl 1-hydroxy-2-naphthoate (10 g, 36 mmol, 1.0 equiv) and trichloro-1-iminoethoxy rhamnose acetate (23.4 g, 53.9 mmol, 1.5 equiv) were dissolved in 300 mL dry DCM with 10 g of activated 4 Å molecular sieves under an N₂ atmosphere. The solution was stirred for 15 min at rt then cooled to −40° C. To this solution was then added BF₃·Et₂O (6.7 mL, 53.9 mmol, 1.5 equiv) dissolved in 25 mL DCM dropwise over 30 min. The solution was stirred for 1 h at this temperature then 1 h at 0° C. The solution was then filtered through celite, added to a separatory funnel, and wash sequentially with water, saturated NaHCO₃, and brine. The organic phase was then dried over Na₂SO₄ and condensed via rotary evaporation. The product was purified by column chromatography (10% to 75% EtOAc/Hexane) affording the product as a reddish powder. 15.2 g, 77%.

The previous product was then dissolved in THF under an N₂ atmosphere and dry Pd/C was added. A hydrogen balloon was then affixed, and the solution was stirred overnight. The solution was filtered through a pad of celite to remove the Pd/C and the solution was condense by rotary evaporation. The resulting material was then dissolved in dry methanol, cooled in an ice water bath, and NaOMe was added until the solution reached a pH of ~9-10. The solution was stirred for 3 h at this temperature at which time H⁺ exchange resin was added slowly until the solution reacted a pH of ~4. The resin was then filtered off and the solution condensed on rotary evaporation and further dried under high vacuum to afford the title compound as a reddish solid. 7.1 g, 89% ¹H NMR (300 MHz, CDCl₃) δ: 1.11 (d, 3H), 3.53-3.80 (m, 3H), 4.18 (dd, 1H), 4.53 (br s, 1H), 4.81 (br s, 1H), 4.99 (br s, 1H), 5.88 (d, 1H), 7.63-7.71 (m, 2H), 7.91 (s, 1H), 8.03 (d, 1H), 8.17 (d, 1H), 8.44 (s, 1H), 11.9-12.05 (br s, 1H). ¹³C NMR (300 MHz, CDCl₃) δ: 16.4, 70.5, 73.4, 73.9, 74.2, 106.4, 106.8, 117.2, 125.0, 126.6, 128.4, 129.0, 129.1, 133.1, 140.5, 161.0, 117.4 LRMS: m/z: [M+Na] calc'd: C₁₇H₁₇NaO₇:356.1 found: 355.9.

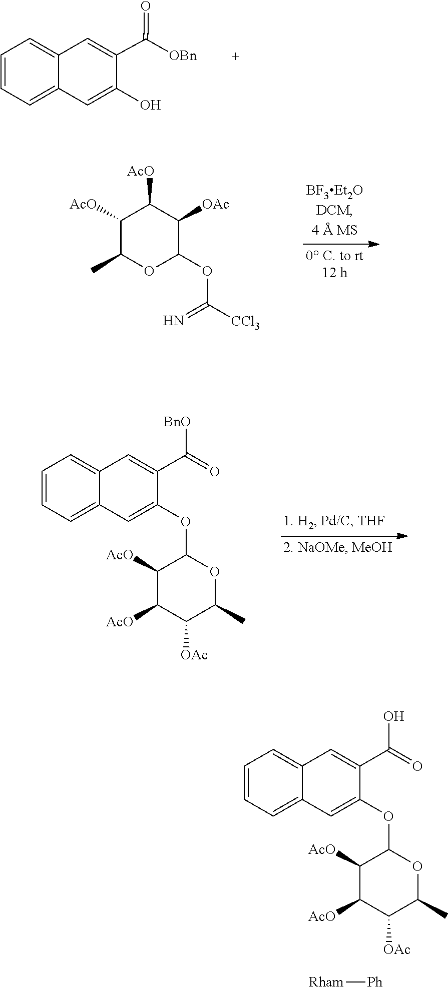

3-(((3R,4R,5R,6S)-3,4,5-Trihydroxy-6-methyltetrahydro-2H-pyran-2-yl)oxy)-2-naphthoic acid (“Rham-3-Naph”). Benzyl 3-hydroxy-2-naphthoate (10 g, 36 mmol, 1.0 equiv) and trichloro-1-iminoethoxy rhamnose acetate (23.4 g, 53.9 mmol, 1.5 equiv) were dissolved in dry 300 mL DCM with 10 g of activated 4 Å molecular sieves under an N₂ atmosphere. The solution was stirred for 15 min at rt then cooled to −40° C. To this solution was then added BF₃·Et₂O dissolved in 10 mL DCM dropwise over 30 min. The solution was stirred for 1 h at this temperature then 1 h at 0° C. The solution was then filtered through celite, added to a separatory funnel, and wash sequentially with water, saturated NaHCO₃, and brine. The organic phase was then dried over Na₂SO₄ and condensed via rotary evaporation. The product was purified by column chromatography (10% to 75% EtOAc/Hexane) affording the product as a yellow powder. 11 g, 55%.

The previous product was then dissolved in THE under an N₂ atmosphere and dry Pd/C was added. A hydrogen balloon was then affixed, and the solution was stirred overnight. The solution was filtered through a pad of celite to remove the Pd/C and the solution was condense by rotary evaporation. The resulting material was then dissolved in dry methanol, cooled in an ice water bath, and NaOMe was added until the solution reached a pH of ~9-10. The solution was stirred for 3 h at this temperature at which time H⁺ exchange resin was added slowly until the solution reacted a pH of ~4. The resin was then filtered off and the solution condensed on rotary evaporation and further dried under high vacuum to afford the title compound as a yellowish solid. 6.2 g, 92%, ¹H NMR (300 MHz, CDCl₃)δ:1.11 (d, 3H), 3.53-3.80 (m, 3H), 4.18 (dd, 1H), 4.53 (br s, 1H), 4.81 (br s, 1H), 4.99 (br s, 1H), 5.88 (d, 1H), 7.63-7.71 (m, 2H), 7.91 (s, 1H), 8.03 (d, 1H), 8.17 (d, 1H), 8.44 (s, 1H), 11.9-12.05 (br s, 1H). ¹³C NMR (300 MHz, CDCl₃)δ:16.4, 70.5, 73.4, 73.9, 74.2, 106.4, 106.8, 117.2, 125.0, 126.6, 128.4, 129.0, 129.1, 133.1, 140.5, 161.0, 117.4 LRMS: m/z: [M+Na] calc'd: C₁₇H₁₇NaO₇:356.1 found: 355.9.

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

For reasons of completeness, various aspects of the invention are set out in the following numbered clauses:

Clause 1. A fluorescent conjugate, wherein the fluorescent conjugate is a compound of formula (A):

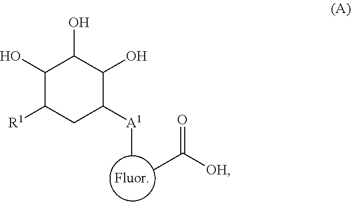

wherein:

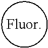

is a fluorophore comprising a conjugated pi bond system;
A¹ is O, S, or NH; and
R¹ is —CH₃, —CH₂OH, —CO₂H, or hydrogen.

Clause 2. A fluorescent conjugate, comprising:
a fluorophore attached to a glycosyl moiety,
   the fluorophore comprising a conjugated pi bond system; and
   the glycosyl moiety comprising a moiety of formula (I), (I′), or (I″):

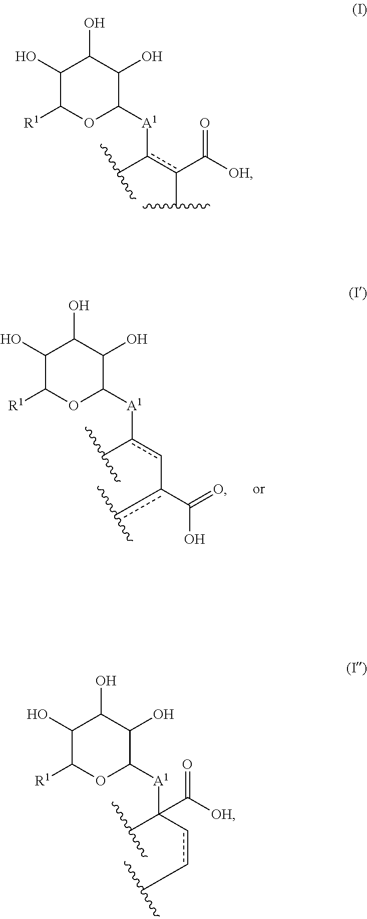

wherein:
A¹ is O, S, or NH;
R¹ is —CH₃, —CH₂OH, —CO₂H, or hydrogen;
[symbol] is an optional double bond; and
[symbol] is an optional single bond.

Clause 3. The fluorescent conjugate of clause 2, the glycosyl moiety comprising at least one pi bond in conjugation with the conjugated pi bond system of the fluorophore.

Clause 4. The fluorescent conjugate of clause 2 or 3, the glycosyl moiety comprising the moiety of formula (I).

Clause 5. The fluorescent conjugate of any one of clauses 2-4, wherein the moiety of formula (I) is a moiety of formula (I-a) or (I-b):

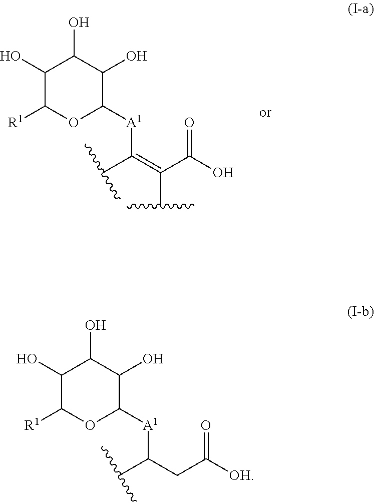

Clause 6. The fluorescent conjugate of clause 5, the glycosyl moiety comprising the moiety of formula (I-a).

Clause 7. The fluorescent conjugate of any one of clauses 2-6, the glycosyl moiety comprising:

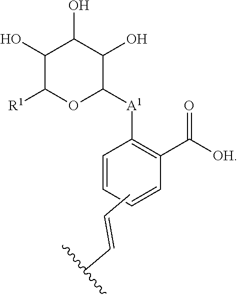

Clause 8. The fluorescent conjugate of clause 5, the glycosyl moiety comprising the moiety of formula (I-b).

Clause 9. The fluorescent conjugate of any one of clauses 2-5 or 8, the glycosyl moiety comprising:

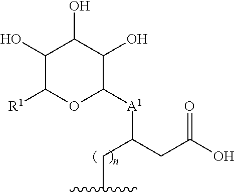

wherein n is 1 to 10.

Clause 10. The fluorescent conjugate of clause 2 or 3, the glycosyl moiety comprising the moiety of formula (I′).

Clause 11. The fluorescent conjugate of clause 10, wherein the moiety of formula (I′) is a moiety of formula (I′-a) or (I′-b):

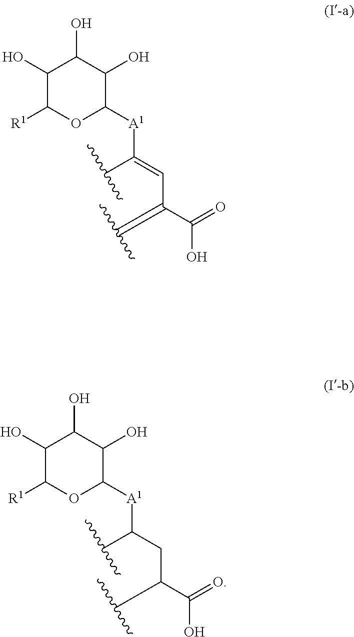

Clause 12. The fluorescent conjugate of clause 2 or 3, the glycosyl moiety comprising the moiety of formula (I″).

Clause 13. The fluorescent conjugate of clause 12, wherein the moiety of formula (I″) is a moiety of formula (I″-a) or (I″-b):

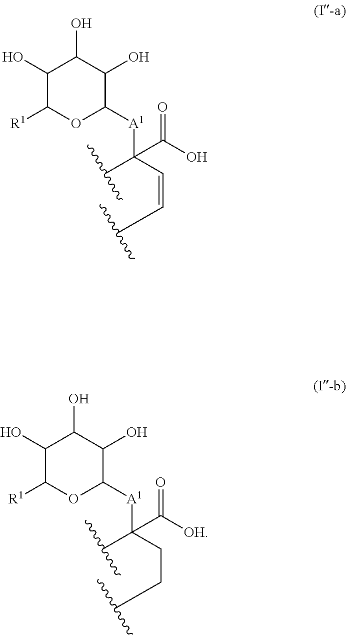

Clause 14. The fluorescent conjugate of any one of clauses 1-13, wherein the fluorophore is a fluorescein, a rhodamine, a cyanine, a xanthene, a quinoline, a boron-dipyrromethene (BODIPY), a coumarin dye, an Alexa Fluor dye, carotene, a non-metalated polypyridine, or a metalated polypyridine.

Clause 15. The fluorescent conjugate of clause 1 or 2, wherein the fluorescent conjugate is:

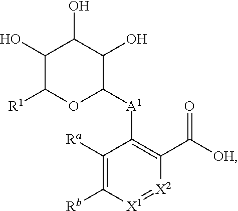

wherein:
A¹ is O, S, or NH;
R^{a} and R^{b}, together with the atoms to which they are attached, form a 6- to 12-membered arene, a 5- to 12-membered partially saturated carbocycle, a 5-14-membered heteroarene, or a 5-14-membered partially saturated heterocycle, each optionally substituted with 1-5 R^{X}; or, alternatively,
R^{a} and R^{b} are each independently hydrogen, C₁₋₆alkyl, C₂₋₆alkenyl, C₂₋₆alkynyl, C₁₋₄haloalkyl, halogen, —CN, oxo, —OR^{10a}, G¹⁰, -OG¹⁰, —C(O)R^{10b}, —CO₂R^{10b}, —SO₃X′, —CO₂X′, —SO₃R^{10b}, —SO₂R^{10b}, —N(R^{10b})₂, —CO₂N(R^{10b})₂, -L¹-CN, -L¹-G¹⁰, -L¹-OR^{10a}, -L¹-OG¹⁰, -L¹-CO₂R^{10b}, -L¹-SO₃X′, -L¹-C(O)R^{10b}, -L¹-SO₃R^{10b}, -L¹-SO₂R^{10b}, -L¹-N(R^{10b})₂, or L¹-CO₂N(R^{10b})₂;
X¹ is C—R^{c} or N;
X² is C—R^{d} or N;
R^{c} and R^{d} are each independently hydrogen, C₁₋₆alkyl, C₂₋₆alkenyl, C₂₋₆alkynyl, C₁₋₄haloalkyl, halogen, —CN, oxo, —OR^{10a}, G¹⁰, -OG¹⁰, —C(O)R^{10b}, —CO₂R^{10b}, —SO₃X′, —CO₂X′, —SO₃R^{10b}, —SO₂R^{10b}, —N(R^{10b})₂, —CO₂N(R^{10b})₂, -L¹-CN, -L¹-G¹⁰, -L¹-OR^{10a}, -L¹-OG¹⁰, -L¹-CO₂R^{10b}, -L¹-SO₃X′, -L¹-C(O)R^{10b}, -L¹-SO₃R^{10b}, -L¹-SO₂R^{10b}, -L¹-N(R^{10b})₂, or -L¹-CO₂N(R^{10b})₂; or, alternatively,
R^{c} and R^{b} and/or R^{c} and R^{d}, together with the atoms to which they are attached, form a 6- to 12-membered arene, a 5- to 12-membered partially saturated carbocycle, a 5-14-membered heteroarene, or a 5-14-membered partially saturated heterocycle, each optionally substituted with 1-5 R^{X};
R^{X}, at each occurrence, is independently C₁₋₆alkyl, C₂₋₆alkenyl, C₂₋₆alkynyl, C₁₋₄fluoroalkyl, halogen, —CN, oxo, G¹⁰, —OR^{10a}, -OG¹⁰, —C(O)R^{10b}, —CO₂R^{10b}, —SO₃X′, —CO₂X′, —SO₃R^{10b}, —SO₂R^{10b}, —N(R^{10b})₂, —CO₂N(R^{10b})₂, -L¹-CN, -L¹-G¹⁰, -L¹-OR^{10a}, -L¹-OG¹⁰, -L¹-CO₂R^{10b}, L¹-C(O)R^{10b}, -L¹-SO₃X′, -L¹-CO₂X′, -L¹-SO₃R^{10b}, -L¹-SO₂R^{10b}, -L¹-N(R^{10b})₂, or -L¹-CO₂N(R^{10b})₂;
R^{10a}, at each occurrence, is independently hydrogen, C₁₋₆alkyl, or C₁₋₂haloalkyl;
R^{10b}, at each occurrence, is independently hydrogen or C₁₋₆alkyl;
G¹⁰, at each occurrence, is independently C₃₋₆carbocyclyl, phenyl, a 4- to 6-membered heterocyclyl, or a 5- to 6-membered heteroaryl, wherein G¹⁰ is optionally substituted with 1-4 substituents independently selected from the group consisting of C₁₋₄alkyl, C₁₋₂haloalkyl, halogen, —CN, —OC₁₋₄alkyl, —OC₁₋₂haloalkyl, —SO₃X′, —CO₂C₁₋₄alkyl, and —CO₂X′;
X′ is a monovalent anion; and
L¹, at each occurrence, is a C₁₋₆alkylene, C₂₋₆alkenylene, or C₂₋₆alkynylene.

Clause 16. The fluorescent conjugate of clause 15, wherein R^{a} and R^{b}, together with the atoms to which they are attached, form the 6- to 12-membered arene or the 5-14-membered heteroarene.

Clause 17. The fluorescent conjugate of clause 15 or 16, wherein X¹ is C—R^{c} or N and X² is C—R^{d}.

Clause 18. The fluorescent conjugate of clause 15 or 16, wherein X¹ is C—R^{c} and X² is C—R^{d} or N.

Clause 19. The fluorescent conjugate of any one of clauses 15-18, wherein C—R^{c} is C—H.

Clause 20. The fluorescent conjugate of any one of clauses 15-19, wherein C—R^{d} is C—H.

Clause 21. The fluorescent conjugate of any one of clauses 1-20, wherein the fluorescent conjugate is:

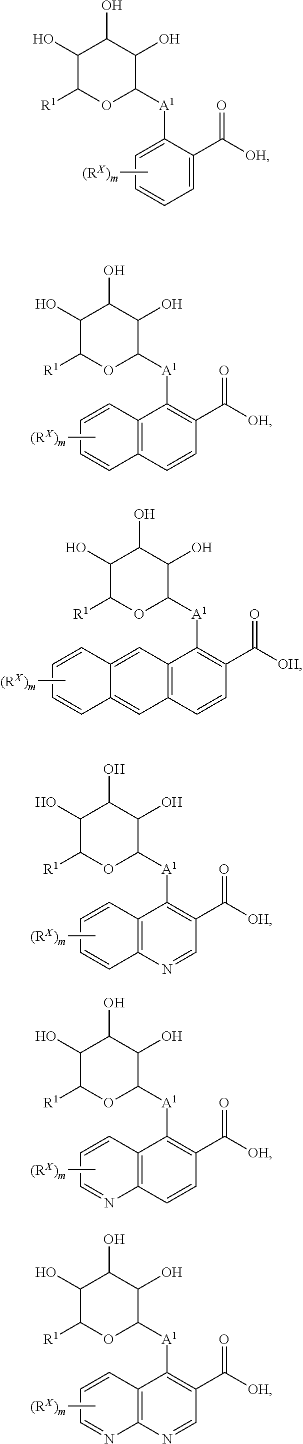

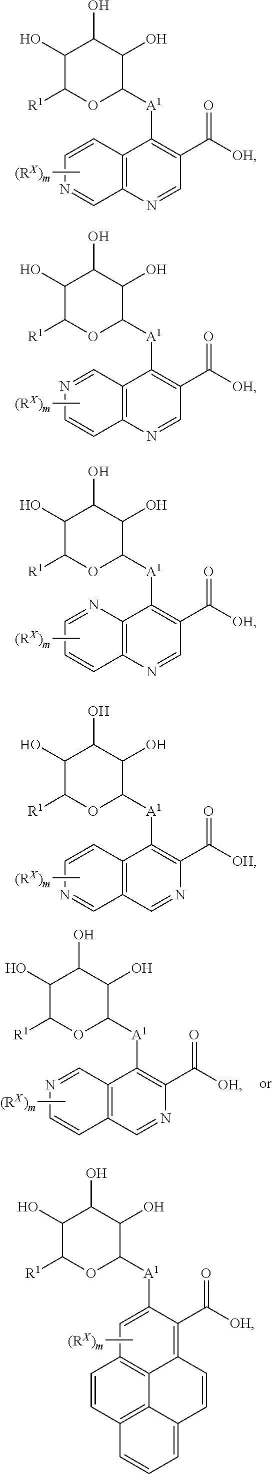

wherein m is 0, 1, or 2.

Clause 22. The fluorescent conjugate of any one of clauses 1-21, wherein R¹ is —CH₃.

Clause 23. The fluorescent conjugate of any one of clauses 1-22, wherein:

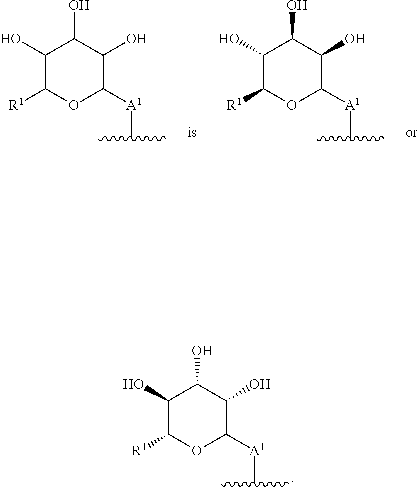

Clause 24. The fluorescent conjugate of any one of clauses 1-23, wherein A¹ is O.

Clause 25. The fluorescent conjugate of any one of clauses 1-24, wherein a metal is bound to the conjugated pi system.

1. A fluorescent conjugate, wherein the fluorescent conjugate is a compound of formula (A): 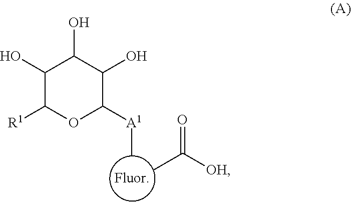
wherein: 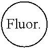
is a fluorophore comprising a conjugated pi bond system;
A¹ is O, S, or NH; and
R¹ is —CH₃, —CH₂OH, —CO₂H, or hydrogen.

2. A fluorescent conjugate, comprising:
a fluorophore attached to a glycosyl moiety,
the fluorophore comprising a conjugated pi bond system; and
the glycosyl moiety comprising a moiety of formula (I), (I′), or (I″): 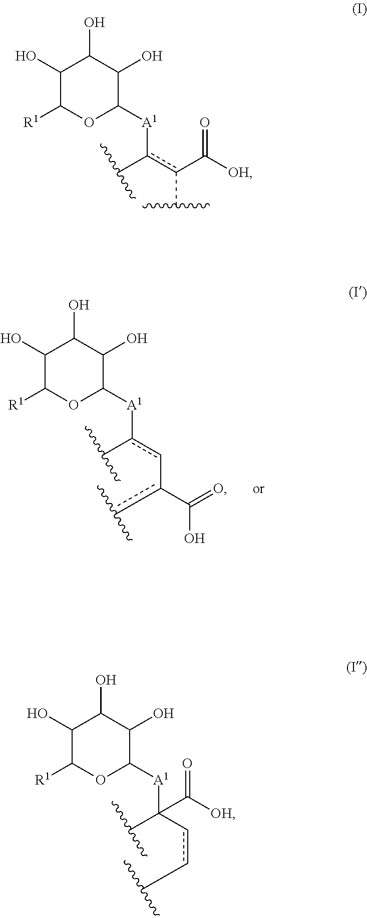
wherein:
A¹ is O, S, or NH;
R¹ is —CH₃, —CH₂OH, —CO₂H, or hydrogen; [symbol]
3 is an optional double bond; and [symbol]
is an optional single bond.

3. The fluorescent conjugate of claim 2, the glycosyl moiety comprising at least one pi bond in conjugation with the conjugated pi bond system of the fluorophore.

4. The fluorescent conjugate of claim 2, the glycosyl moiety comprising the moiety of formula (I).

5. The fluorescent conjugate of claim 2, wherein the moiety of formula (I) is a moiety of formula (I-a) or (I-b):

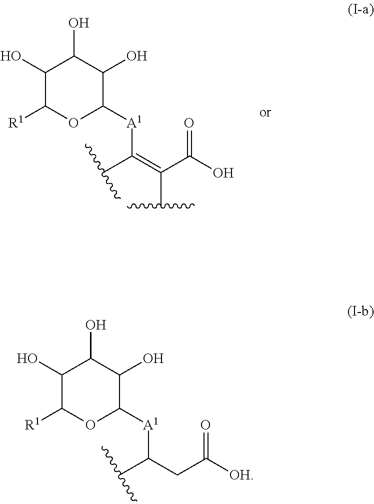

6. The fluorescent conjugate of claim 5, the glycosyl moiety comprising the moiety of formula (I-a).

7. The fluorescent conjugate of claim 2, the glycosyl moiety comprising:

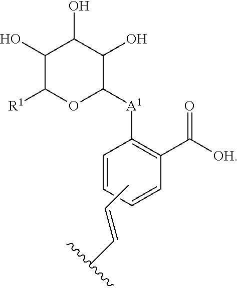

8. The fluorescent conjugate of claim 5, the glycosyl moiety comprising the moiety of formula (I-b).

9. The fluorescent conjugate of claim 2, the glycosyl moiety comprising: 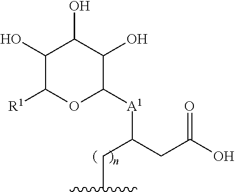
wherein n is 1 to 10.

10. The fluorescent conjugate of claim 2, the glycosyl moiety comprising the moiety of formula (I′).

11. The fluorescent conjugate of claim 10, wherein the moiety of formula (I′) is a moiety of formula (I′-a) or (I′-b):

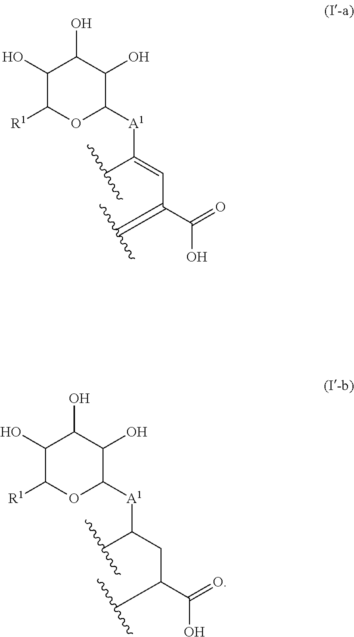

12. The fluorescent conjugate of claim 2, the glycosyl moiety comprising the moiety of formula (I″).

13. The fluorescent conjugate of claim 12, wherein the moiety of formula (I″) is a moiety of formula (I″-a) or (I″-b):

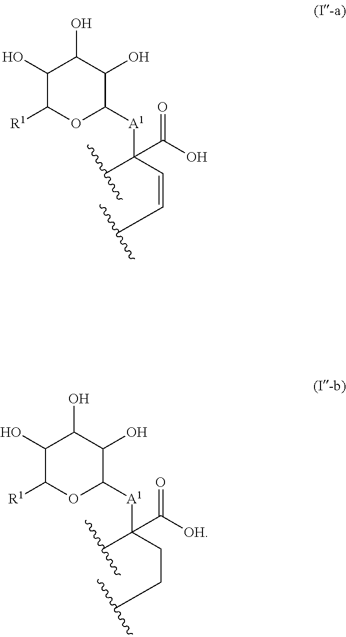

14. The fluorescent conjugate of claim 1, wherein the fluorophore is a fluorescein, a rhodamine, a cyanine, a xanthene, a quinoline, a boron-dipyrromethene (BODIPY), a coumarin dye, an Alexa Fluor dye, carotene, a non-metalated polypyridine, or a metalated polypyridine.

15. The fluorescent conjugate of claim 1, wherein the fluorescent conjugate is: 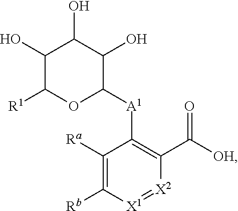
wherein:
A¹ is O, S, or NH;
R^{a} and R^{b}, together with the atoms to which they are attached, form a 6- to 12-membered arene, a 5- to 12-membered partially saturated carbocycle, a 5-14-membered heteroarene, or a 5-14-membered partially saturated heterocycle, each optionally substituted with 1-5 R^{X}; or, alternatively,
R^{a} and R^{b} are each independently hydrogen, C₁₋₆alkyl, C₂₋₆alkenyl, C₂₋₆alkynyl, C₁₋₄haloalkyl, halogen, —CN, oxo, —OR^{10a}, G¹⁰, -OG¹⁰, —C(O)R^{10b}, —CO₂R^{10b}, —SO₃X′, —CO₂X′, —SO₃R^{10b}, —SO₂R^{10b}, —N(R^{10b})₂, —CO₂N(R^{10b})₂, -L¹-CN, -L¹-G¹⁰, -L¹-OR^{10a}, -L¹-OG¹⁰, -L¹-CO₂R^{10b}, -L¹-SO₃X′, -L¹-C(O)R^{10b}, -L¹-SO₃R^{10b}, -L¹-SO₂R^{10b}, -L¹-N(R^{10b})₂, or -L¹-CO₂N(R^{10b})₂;
X¹ is C—R^{c} or N;
X² is C—R^{d} or N;
R^{c} and R^{d} are each independently hydrogen, C₁₋₆alkyl, C₂₋₆alkenyl, C₂₋₆alkynyl, C₁₋₄haloalkyl, halogen, —CN, oxo, —OR^{10a}, G¹⁰, -OG¹⁰, —C(O)R^{10b}, —CO₂R^{10b}, —SO₃X′, —CO₂X′, —SO₃R^{10b}, —SO₂R^{10b}, —N(R^{10b})₂, —CO₂N(R^{10b})₂, -L¹-CN, -L¹-G¹⁰, -L¹-OR^{10a}, -L¹-OG¹⁰, -L¹-CO₂R^{10b}, -L¹-SO₃X′, -L¹-C(O)R^{10b}, -L¹-SO₃R^{10b}, -L¹-SO₂R^{10b}, -L¹-N(R^{10b})₂, or -L¹-CO₂N(R^{10b})₂; or, alternatively,
R^{c} and R^{b} and/or R^{c} and R^{d}, together with the atoms to which they are attached, form a 6- to 12-membered arene, a 5- to 12-membered partially saturated carbocycle, a 5-14-membered heteroarene, or a 5-14-membered partially saturated heterocycle, each optionally substituted with 1-5 R^{X};
R^{X}, at each occurrence, is independently C₁₋₆alkyl, C₂₋₆alkenyl, C₂₋₆alkynyl, C₁₋₄fluoroalkyl, halogen, —CN, oxo, G¹⁰, —OR^{10a}, -OG¹⁰, —C(O)R^{10b}, —CO₂R^{10b}, —SO₃X′, —CO₂X′, —SO₃R^{10b}, —SO₂R^{10b}, —N(R^{10b})₂, —CO₂N(R^{10b})₂, -L¹-CN, -L¹-G¹⁰, -L¹-OR^{10a}, -L¹-OG¹⁰, -L¹-CO₂R^{10b}, -L¹-C(O)R^{10b}, -L¹-SO₃X′, -L¹-CO₂X′, -L¹-SO₃R^{10b}, -L¹-SO₂R^{10b}, -L¹-N(R^{10b})₂, or -L¹-CO₂N(R^{10b})₂;
R^{10a}, at each occurrence, is independently hydrogen, C₁₋₆alkyl, or C₁₋₂haloalkyl;
R^{10b}, at each occurrence, is independently hydrogen or C₁₋₆alkyl;
G¹⁰, at each occurrence, is independently C₃₋₆carbocyclyl, phenyl, a 4- to 6-membered heterocyclyl, or a 5- to 6-membered heteroaryl, wherein G¹⁰ is optionally substituted with 1-4 substituents independently selected from the group consisting of C₁₋₄alkyl, C₁₋₂haloalkyl, halogen, —CN, —OC₁₋₄alkyl, —OC₁₋₂haloalkyl, —SO₃X′, —CO₂C₁₋₄alkyl, and —CO₂X′;
X′ is a monovalent anion; and
L¹, at each occurrence, is a C₁₋₆alkylene, C₂₋₆alkenylene, or C₂₋₆alkynylene.

16. The fluorescent conjugate of claim 15, wherein R^{a} and R^{b}, together with the atoms to which they are attached, form the 6- to 12-membered arene or the 5-14-membered heteroarene.

17. The fluorescent conjugate of claim 15, wherein X¹ is C—R^{c} or N and X² is C—R^{d}.

18. The fluorescent conjugate of claim 15, wherein X¹ is C—R^{c} and X² is C—R^{d} or N.

19. The fluorescent conjugate of claim 15, wherein C—R^{c} is C—H.

20. The fluorescent conjugate of claim 15, wherein C—R^{d} is C—H.

21. The fluorescent conjugate of claim 1, wherein the fluorescent conjugate is: 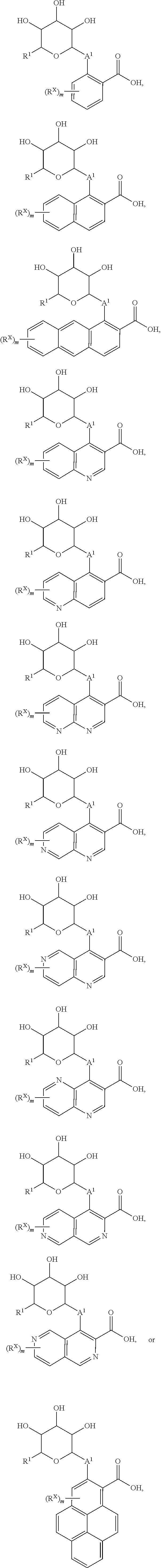
wherein m is 0, 1, or 2.

22. The fluorescent conjugate of claim 1, wherein R¹ is —CH₃.

23. The fluorescent conjugate of claim 1, wherein:

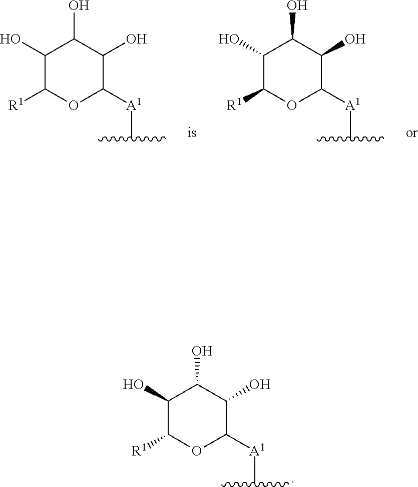

24. The fluorescent conjugate of claim 1, wherein A¹ is O.

25. The fluorescent conjugate of claim 1, wherein a metal is bound to the conjugated pi system.
